(19) United States
(12) Patent Application Publication
(10) Pub. No.: US 2026/0048342 A1
(43) Pub. Date: Feb. 19, 2026

(54) FOLDABLE SOLAR DESALINATION DEVICE WITH NO LIQUID DISCHARGE

(71) Applicant: Khalifa University of Science and Technology, Abu Dhabi (AE)

(72) Inventors: TieJun ZHANG, Abu Dhabi (AE); Mohamed Abbas ABDELSALAM, Abu Dhabi (AE); Muhammad SAJJAD, Abu Dhabi (AE); Hongxia LI, Abu Dhabi (AE); Faisal AL MARZOOQI, Abu Dhabi (AE)

(21) Appl. No.: 19/101,020

(22) PCT Filed: Oct. 20, 2022
(86) PCT No.: PCT/IB2022/060111

§ 371 Date: Feb. 4, 2025

(51) Int. Cl. B01D 1/30; B01D 1/00; B01D 5/00; C02F 1/14; C02F 103/08

(52) U.S. Cl. CPC B01D 1/30; B01D 1/0035; B01D 5/006; C02F 1/14; C02F 2103/08

(57) ABSTRACT

A desalination and brine treatment apparatus (100) includes a support (120) and at least one evaporator component (122) in contact with the support (120), wherein one or more of the support (120) and the evaporator component (122) include mesh (150). Methods of desalination and brine treatment are provided for removing salt (196) from saltwater (102) utilizing energy such as solar energy (104).

### BACKGROUND

Efficient solar vapor generation and brine treatment are important for various applications ranging from large-scale power generation, desalination plants, and enhanced oil recovery to compact and portable applications like drinking water purification and sterilization. However, conventional solar vapor generation techniques usually rely on costly and cumbersome optical concentration systems with relatively low efficiency due to bulk heating of the entire liquid volume. Conventional desalination and enhanced oil recovery technologies produce an undesired concentrated brine as waste. The brine is regularly injected back to sea, causing the seawater salt concentration to increase which consequently affects the aquatic ecosystem. Therefore, there is a need for efficient solar vapor generation systems without brine liquid discharge.

### SUMMARY

According to one aspect, a desalination and brine treatment apparatus includes a support and at least one evaporator component in contact with the support, wherein one or more of the support and the evaporator component include mesh.

According to another aspect, a method of desalination and brine treatment includes providing a desalination apparatus including a support and at least one evaporator component in contact with the support. The method further includes contacting the desalination apparatus with saltwater and transporting the saltwater through the support via capillary flow towards the evaporator component in contact with support. The method further includes evaporating the saltwater on the evaporator component utilizing solar energy sufficient to create water vapor and precipitate and crystallize salt. The method further includes condensing the water vapor.

According to another aspect, a porous apparatus for saltwater desalination includes a hydrophilic support and an evaporator component with a base layer and a Polydimethylsiloxane hydrophobic film layer, wherein the hydrophilic support is in contact with the evaporator component and the hydrophilic support and the base layer include a mesh including one or more materials selected from Ti and TiO2.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates a desalination device with an enlarged view of a mesh material, according to some embodiments.

FIG. 2A illustrates a side view of a flower-shaped desalination device with a support and evaporator components, according to some embodiments.

FIG. 2B illustrates a top view of a flower-shaped desalination device with two evaporator components, according to some embodiments.

FIG. 2C illustrates a top view of a flower-shaped desalination device with four evaporator components, according to some embodiments.

FIG. 2D illustrates a top view of a flower-shaped desalination device with six evaporator components, according to some embodiments.

FIG. 2E illustrates a top view of a flower-shaped desalination device with six evaporator components and sub-structures, according to some embodiments.

FIG. 3A illustrates a side view of a cactus-shaped desalination device with a support and evaporator components, according to some embodiments.

FIG. 3B illustrates a top view of a cactus-shaped desalination device with a support and evaporator components, according to some embodiments.

FIG. 4A illustrates a schematic of a flower-shaped desalination device with a support, evaporator components, a base layer, and a hydrophobic layer, according to some embodiments.

FIG. 4B illustrates a side view of flower-shaped desalination device with a support, evaporator components, a base layer, and a hydrophobic layer, according to some embodiments.

FIG. 5A illustrates a 3D model of mesh in a desalination device, according to some embodiments.

FIG. 5B illustrates a 2D view of the longitudinal cross-sections of a mesh unit cell in a desalination device, according to some embodiments.

FIG. 5C illustrates a 2D view of the lateral cross-sections of a mesh unit cell in a desalination device, according to some embodiments.

FIG. 6 illustrates a process of hydrothermal synthesis for the alkaline treatment of mesh, according to some embodiments.

FIG. 7A illustrates a transparent spherical chamber used for a water collection experiment, according to some embodiments.

FIG. 7B illustrates an experimental setup during an outdoor experiment, according to some embodiments.

FIG. 7C illustrates a schematic diagram for a general experimental setup for the water collection process, according to some embodiments.

FIG. 7D illustrates a schematic diagram of multiple desalination devices for a water desalination process, according to some embodiments.

FIG. 8 illustrates a method 200 of solar thermal desalination and brine treatment, according to some embodiments.

FIG. 9A illustrates the measured absorptance of TiO₂/Ti as a flat substrate and a 2D mesh, according to some embodiments.

FIG. 9B illustrates the measured absorptance of TiO₂/Ti as a 3D dry and wet mesh, according to some embodiments.

FIG. 10A illustrates low magnification SEM images of as-oxidized TiO₂/Ti mesh (1M NaOH_{(aq)}, 220° C.), according to some embodiments.

FIG. 10B illustrates high magnification SEM images of as-oxidized TiO₂/Ti mesh (1M NaOH_{(aq)}, 220° C.), according to some embodiments.

FIG. 10C illustrates evolution of the waterfront and wicking of the deionized water with time for the oxidized titanium mesh, according to some embodiments.

FIG. 11A illustrates optical images comparing the anticorrosive performance of TiO₂/Ti and CuO/Cu mesh after 6 hours of dipping in water containing 3.5 wt% NaCl, according to some embodiments.

FIG. 11B illustrates measured absorptance spectra of methylene blue to investigate the antifouling performance of the TiO₂/Ti mesh, according to some embodiments.

FIG. 11C illustrates methylene blue solution before photocatalysis (200 ppm) and after photocatalysis TiO₂ NSs@ Ti mesh (45±3 ppm), according to some embodiments.

FIG. 12A illustrates temperature as a function of time for an outdoor experiment using a TiO₂/Ti mesh foldable structure (with four evaporator components) for 3.5 wt% salt concentration, according to some embodiments.

FIG. 12B illustrates mass change as a function of time for an outdoor experiment using a TiO₂/Ti mesh foldable structure (four evaporator components) for 3.5 wt% salt concentration, according to some embodiments.

FIG. 13A illustrates titanium mesh of a desalination device before cleaning with collected desalinated water, according to some embodiments.

FIG. 13B illustrates titanium mesh of a desalination device after cleaning with collected desalinated water, according to some embodiments.

FIG. 13C illustrates titanium mesh of a desalination device before cleaning with real seawater, according to some embodiments.

FIG. 13D illustrates titanium mesh of a desalination device after cleaning with real seawater, according to some embodiments.

FIG. 14A illustrates salt crystallization on a desalination device using artificial brines of 24 wt%, according to some embodiments.

FIG. 14B illustrates salt crystallization on a desalination device using artificial brines of 10.5 wt%, according to some embodiments.

FIG. 15A illustrates a bottom view of a desalination device with a mesh base layer and a polydimethylsiloxane layer before being placed in saline water, according to some embodiments.

FIG. 15B illustrates a bottom view of a desalination device with a mesh base layer and a polydimethylsiloxane layer after an evaporation experiment using 24 wt% of pure NaCl salt, according to some embodiments.

FIG. 15C illustrates a top view of a desalination device with a mesh base layer and a polydimethylsiloxane layer after an evaporation experiment using 24 wt% of pure NaCl salt, according to some embodiments.

FIG. 15D illustrates a bottom view of a desalination device with a mesh base layer and a polydimethylsiloxane layer after self-cleaning at night due to the back diffusion of salt and passive peeling of salt, according to some embodiments.

FIG. 15E illustrates a performance comparison between flower-like desalination devices with and without base mesh layer and polydimethylsiloxane composite layer in terms of mass change and evaporation flux, according to some embodiments.

FIG. 15F illustrates a side view of 1.6 g of salt accumulated in both a flower-like desalination device and a desalination device with a base mesh layer and a polydimethylsiloxane layer, where the salt is accumulated on the bottom side only, according to some embodiments.

FIG. 15G illustrates a bottom view of salt accumulated in both a flower-like desalination device and a desalination device with a base mesh layer and a polydimethylsiloxane layer, according to some embodiments.

FIG. 15H illustrates a schematic of passive salt peeling from a desalination device with a base layer and a polydimethylsiloxane layer, according to some embodiments.

FIG. 15I illustrates a schematic of passive salt peeling from a flower-like desalination device, according to some embodiments.

FIG. 16A illustrates the mass change as a function of time for salt concentrations using the flower shaped structure under simulated one sun irradiance, according to some embodiments.

FIG. 16B illustrates the mass change as a function of time for salt concentrations by using a desalination device with base mesh-polydimethylsiloxane composite layer under simulated one sun irradiance, according to some embodiments.

FIG. 17 illustrates a comparison between the evaporation performance of the indoor and outdoor experiments for the real 24 wt% seawater brine, according to some embodiments.

FIG. 18A illustrates a top view of the amount of self-peeled salt from a desalination device with a base mesh layer and a polydimethylsiloxane layer, according to some embodiments.

FIG. 18B illustrates the amount of self-removed salt and showing the bottom side of the desalination device with a base mesh layer and a polydimethylsiloxane layer, according to some embodiments.

FIG. 18C illustrates a dissolved interfacial layer in a desalination device with a base layer and a polydimethylsiloxane layer device, according to some embodiments.

### DETAILED DESCRIPTION

Embodiments of the present disclosure describe an all-in-one desalination technology for solar vapor generation and freshwater collection, brine treatment, and other industrial water treatment applications. This all-in-one desalination device can operate without substantially any liquid brine discharge. In the evaporator, foldable and anti-corrosive/fouling mesh can be used to enable simultaneous saline water wicking and effective light absorption and evaporation. Structures including evaporator components and a support may include micro-wired superhydrophilic meshes. When embedded in a low density thermally insulated foam, a porous superhydrophilic support can act as the wick to support unidirectional water transport to evaporator components. Combining a superhydrophilic mesh with a hydrophobic layer can promote directional salt collection on the bottom side of the device. Integrating an evaporator and crystallizer provides a sustainable and scalable solution for both freshwater production and salt collection without liquid discharge.

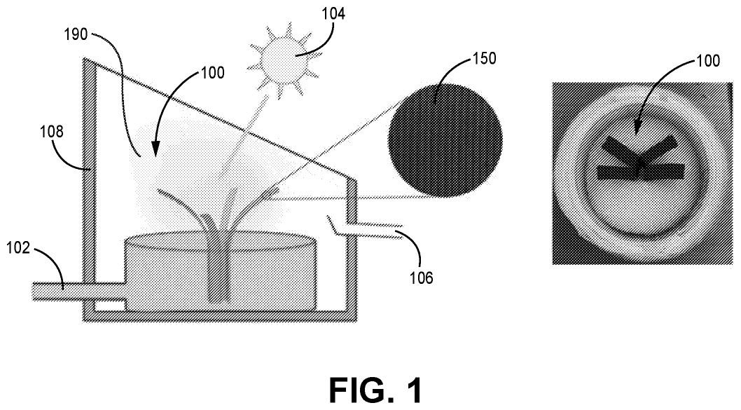

FIG. 1 illustrates an example of a desalination device 100 for removing salt from saltwater 102. FIG. 1 includes desalination device 100, saltwater 102, sunlight 104, fresh water 106, insulating material 108, an enlarged view of mesh material 150, and water vapor 190, according to some embodiments. Desalination device 100 can be utilized to produce fresh water 106 from saltwater 102. Thermal energy from sunlight 104 can drive the evaporation of water and salt crystallization. Desalination device 100 can be substantially shaped like a plant. For example, desalination device 100 can be substantially shaped like a flower. In another example, Desalination device 100 can be substantially shaped like a tree, shrub, herb, crop, grass, creeper, climber, fern, moss, or aquatic plant. Additionally, desalination device 100 can have a flat or curved top surface similar to the shape of a solar panel. Desalination device 100 can be surrounded by or be in contact with insulating material 108. Insulating material 108 can be any insulating material for insulating thermal energy. Insulating material 108 can be used to reduce the bulk heating of water. For example, insulating material 108 can be a low-density thermally insulating foam. Any portion of desalination device 100 can be substantially water-wicking.

Desalination device 100 can include material substantially in a mesh 150. Mesh 150 can have a mesh geometry. For example, mesh 150 can include Shute and warp wires. Mesh 150 may include a metallic, polymeric, or ceramic mesh. In one example, mesh 150 includes titanium mesh. In another example, mesh 150 includes Ti/TiO₂. Mesh 150 can be hydrophilic. Mesh 150 can be a flexible porous sheet or flexible porous structure. Mesh 150 can be shaped like a flower petal.

Desalination device 100 can be placed in saltwater 102. Desalination device 100 can be floating in or on top of saltwater 102. Desalination device 100 can be in contact with saltwater 102. Saltwater 102 may include seawater, brine, and saline water. In one example, saltwater 102 is greater than about 0.1 wt% salt. Saltwater 200 can be between about 1 wt% and about 28 wt%. In another example, saltwater 102 is between about 3.5 wt% salt and about 24 wt% salt. Saltwater 102 can flow through any portion of desalination device 100. In one example, saltwater 102 can flow through desalination device 100 via capillary flow. In another example, saltwater 102 can flow through desalination device 100 via unidirectional capillary flow.

In one example, sunlight 104 provides thermal energy to desalination device 100. Sunlight 104 can be absorbed by any portion of desalination device 100 to generate heat. Desalination device 100 can include a low conductivity material to prevent heat loss from an absorption surface. Saltwater 200 can flow through desalination device 100 and evaporate due to sufficient thermal energy on or around desalination device 100. The evaporation creates water vapor 190.

Water vapor 190 can be present in, on, or around desalination device 100 from the evaporation of saltwater 102 or fresh water 106. Water vapor 190 can be substantially salt free and can be present with or without sunlight 104. In one example, water vapor 190 is between 97% and 100% salt free. In another example, water vapor 190 is 100% salt free. Fresh water 106 can be present from condensed water vapor 190. Fresh water 106 can be substantially salt free and can be present with or without sunlight 104. In one example, fresh water 106 is between 97% and 100% salt free. In another example, fresh water 106 is 100% salt free.

Desalination device 100 is important for removing salt from saltwater 102. The world is continuing to require more fresh water for drinking water, industrial uses, and other important fresh water uses. Desalination device 100 can be made from inexpensive components and provides a self-sustaining salt removal process. Importantly, desalination device 100 can provide salt removal without brine liquid discharge.

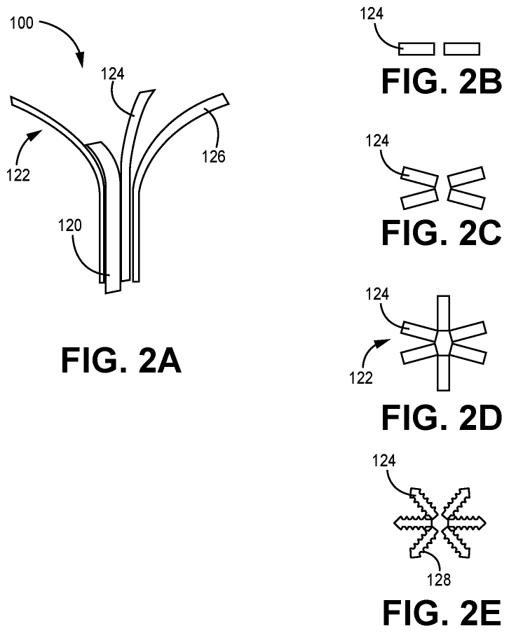

FIG. 2A illustrates an example of a desalination device 100 for a salt removal process. FIG. 2A illustrates a desalination device 100, support 120, evaporator component 122, first side 124, and second side 126, according to some embodiments. In one example, desalination device 100 includes support 120, evaporator component 122, first side 124 and second side 126. In one example, desalination device 100 includes one or more evaporator components 122. Desalination device 100 includes one or more supports 120. For example, desalination device 100 may include one support 120 or may include two to four supports 120. In another example, desalination device 100 includes more than four supports 120. If desalination device 100 includes more than one support 120, the multiple supports 120 may be in contact with one another or separated. Optionally, desalination device 100 includes an evaporator component sub-structure 128. Support 120 is in contact with evaporator component 122. In one example, support 120 and evaporator component 122 are one singular structure. In another example, support 120 and evaporator component 122 are connected separate structures. First side 124 can be a surface on the opposite side of the evaporator component 122 from second side 126. Support 120 can act as a wick for water transport.

Evaporator component 122 can be substantially flat or curved. As an example, evaporator component 122 can have a cross-sectional shape of a triangle, square, rectangle, circle, or polygon. Evaporator component 122 can include a tubular structure. In another example, evaporator component 122 is substantially shaped like a rectangular prism, triangular prism, sphere, cone, pyramid, and cylinder. Each evaporator component 122 can be in contact with another evaporator component 122 or have a space separating the evaporator components 122. For example, all evaporator components 122 can be in contact with at least one other evaporator component 122. Furthermore, evaporator components 122 can be at various angles of contact with support 120.

FIGS. 2B-2E illustrate a top view of the desalination device 100, according to some embodiments. The top view in FIGS. 2B-2E illustrate the evaporator component 122 and the first side 124. FIG. 2B illustrates desalination device 100 with two evaporator components 122. FIG. 2C illustrates desalination device 100 with four evaporator components 122. FIG. 2D illustrates desalination device 100 with six evaporator components 122. FIGS. 2A-2D illustrate examples of multiple evaporator components 122, which can be increased as desired to increase surface area or enhance evaporation performance.

FIG. 2E illustrates desalination device 100 with six evaporator components 122 and evaporator component sub-structure 128. Evaporator component sub-structure 128 can be included in desalination device 100 with any amount of evaporator components 122. In one example, evaporator component sub-structure 128 increases the surface area of evaporator component 122. Evaporator component sub-structure 128 can optionally be in the form of a bump, wave, protrusion, or any other shape that increases the surface area of evaporator component 122. The evaporator component sub-structure 128 can provide extra surface area for salt to nucleate, leading to easy shedding and collection of salt. Additionally, the evaporator component sub-structure 128 can provide additional surface area for evaporation.

Importantly, the number of evaporator components 122 can be increased or decreased depending on the desired surface area, evaporation flux (rate), cost of materials, or light absorption requirements. Furthermore, evaporator components 122 can be utilized to support additional structures, layers, or components on top of evaporator components 122. This makes evaporator components 122 robust for small and large-scale operation in a variety of environments.

Desalination device 100 may be a foldable structure. Any portion of desalination device 100 may be foldable. Foldable structures can be shaped in a desired way for a particular design without being broken. In one example, the material of desalination device 100 can be rolled and bended to achieve a require geometry such as flower shaped structure.

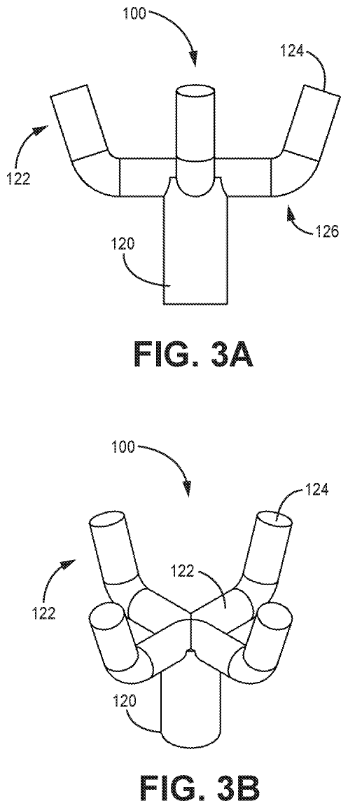

FIG. 3A illustrates an example of a desalination device 100 for a salt removal process. FIG. 3A illustrates a side-view of desalination device 100 with support 120, evaporator component 122, first side 124 and second side 126, according to some embodiments. In one example, desalination device 100 can be substantially shaped like a cactus. Desalination device 100 can have one or more of oblique and straight evaporator components 122. For example, desalination device 100 can include one straight evaporator component 122 and four oblique evaporator components 122. In another example, desalination device 100 can include four straight evaporator components 122.

Support 120 is in contact with evaporator component 122. In one example, support 120 and evaporator component 122 are one singular structure. In another example, support 120 and evaporator component 122 are connected separate structures. First side 124 can be a surface on the opposite side of the evaporator component 122 from second side 126. Evaporator component 122 can be substantially perpendicular or substantially parallel to support 120, or some angle in between, for example. Evaporator component 122 can distally extend from support 120. Evaporator component 122 can be substantially flat or curved. As an example, evaporator component 122 can have a cross-sectional shape of a triangle, square, rectangle, circle, or polygon. Evaporator component 122 can include a tubular structure. In another example, evaporator component 122 is substantially shaped like a rectangular prism, triangular prism, sphere, cone, pyramid, and cylinder. FIG. 3B illustrates a top view of desalination device 100 with support 120, evaporator component 122 and first side 124, according to some embodiments.

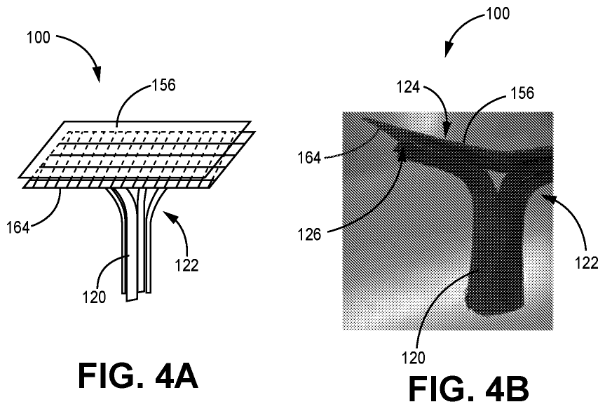

FIG. 4A illustrates a schematic diagram of a desalination device 100 for a salt removal process. FIG. 4A illustrates a schematic diagram of a desalination device 100 including a support 120, evaporator component 122, hydrophobic layer 156, and base layer 164, according to some embodiments. For example, support 120 is in contact with evaporator component 122. In one example, evaporator component 122 is in contact with base layer 164. Base layer 164 is in contact with hydrophobic layer 156. Support 120 can be in contact with base layer 164 and hydrophobic layer 156. For example, support 120 can be substantially perpendicular to base layer 164.

In one example, base layer 164 is a polymeric, metallic, or ceramic material. In another example, base layer 164 is an oxidized polymeric, metallic, or ceramic material. For example, base layer 164 can be hydrophilic and can include one or more of Ti and TiO₂. Hydrophobic layer 156 can include any material that has hydrophobic properties. For example, hydrophobic layer 156 includes Polydimethylsiloxane (PDMS). Hydrophobic layer 156 can be substantially transparent. For example, hydrophobic layer 156 can be greater than 60% transparent. Hydrophobic layer 156 may be highly transparent to allow solar light to penetrate through it. In one example, the transparency of hydrophobic layer 156 ranges from 80% to 95%, depending on the thickness and temperature. Hydrophobic layer 156 and base layer 164 can act as an additional evaporator component 122.

Hydrophobic layer 156 can include any material that has hydrophobic properties. For example, hydrophobic layer 156 includes Polydimethylsiloxane (PDMS). PDMS is a stable hydrophobic silicon rubber that belongs to silicones or siloxanes group. Other transparent siloxane compounds including Phenyltrimethoxysilane (PTMS), 3-Glycidoxypropylmethyldimethoxysilane (GPDMS), Dimethoxydimethylsilane (DMDS) and any hydrophobic transparent rubber material can be used for hydrophobic layer 156. Hydrophobic layer 156 can be transparent. Hydrophobic layer 156 can prevent salt precipitation in desired areas of desalination device 100. Additionally, hydrophobic layer 156 can force saltwater to propagate in desired areas of desalination device 100 without sacrificing sunlight absorption or vapor generation. An additional layer of one or more of weave material 152 and hydrophobic layer 156 can be placed in between or on top of any layer included in mesh 150. An additional layer can be substantially hydrophilic. An additional layer may be placed between support 120 and hydrophobic layer 156.

Importantly, a transparent hydrophobic layer 156 can provide hydrophobic properties to desalination device 100 without sacrificing sunlight absorption. This can provide directional water transport in desalination device 100. Directional water transport is important for crystallizing salt in certain areas of desalination device 100.

FIG. 4B illustrates an optical picture of a design showing support 120, evaporator component 122, first side 124, second side 126, hydrophobic layer 156, and base layer 164, according to some embodiments. Desalination device 100 exhibits excellent vapor evaporation flux and salt collection without liquid discharge making it effective for brine treatment. Base layer 164 and evaporator component 122 do not both have to be present in desalination device 100.

Importantly, the number of evaporator components 122 can be increased or decreased depending on the desired surface area, evaporation flux, cost of materials, or light absorption requirements. Furthermore, evaporator components 122 can be utilized to support additional structures, layers, or components such as base layer 164 or hydrophobic layer 156. Evaporator components 122 can be a single-layer evaporator sufficient to allow water propagation and vaporization under sunlight. Desalination device 100 can provide a large surface area for sunlight absorption on top of the device as shown in FIG. 4A. This large surface area can also provide benefits such as a large area for salt nucleation on one side and a large area for sunlight absorption.

First side 124 of desalination device 100 may be directed towards the sun. First side 124 may be considered the “top” side. For example, first side 124 of desalination device 100 may be facing opposite any water. Second side 126 of desalination device 100 may provide an area for salt nucleation and may face any water. Second side 126 may be considered the “bottom” side. In one example, the crystallized salt may accumulate on the bottom of desalination device 100. In another example, hydrophobic layer 156 and base layer 164 are substantially parallel with the water line. In another example, hydrophobic layer 156 and base layer 164 may be angled toward the sun for more efficient evaporation or sunlight absorption. In one non-limiting example, the cross-sectional shape of hydrophobic layer 156 and base layer 164 is selected from a circle, oval, triangle, square, rectangle, or polygon. Both hydrophobic layer 156 and base layer 164 may be any shape sufficient to have a surface for efficient sunlight absorption. Both hydrophobic layer 156 and base layer 164 may be substantially flat as shown in FIG. 4A or curved as shown in FIG. 4B. Any portion of desalination device 100 may be flexible and bendable for optimizing sunlight absorption and salt removal. Any portion of desalination device 100 may be flexible and bendable for optimizing strength, weight, and support.

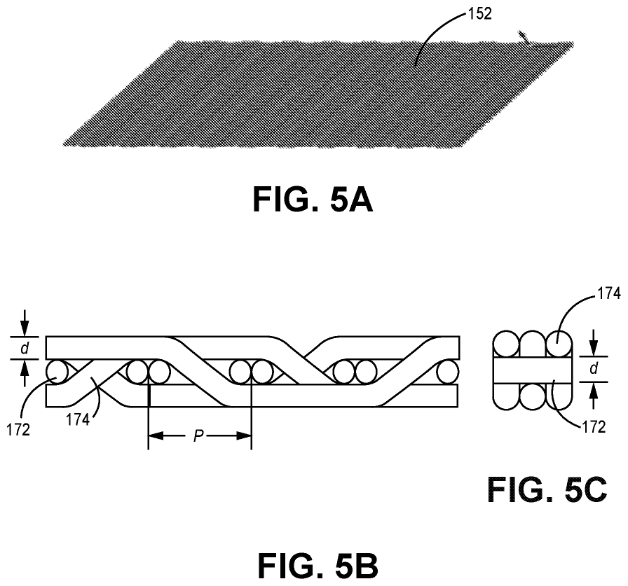

FIG. 5A illustrates a 3D model of material geometry in an example desalination device 100, according to some embodiments. FIG. 5A shows weave material 152. In one example, weave material 152 includes a polymeric, metallic, or ceramic material. In another example, weave material 152 includes one or more oxidized materials selected from polymeric, metallic, and ceramic. For example, weave material 152 can include one or more of Ti and TiO₂. In one example, weave material 152 has a thickness between 0.1 mm and 1 cm. In another example, the weave material 152 has a thickness between 0.5 mm and 1 mm. For example, the weave material 152 can have a thickness of 0.81 mm.

FIG. 5B illustrates a 2D view of the longitudinal cross-sections of a weave material 152 unit cell in a desalination device 100, according to some embodiments. FIG. 5C illustrates a 2D view of the lateral cross-sections of a weave material 152 unit cell in a desalination device 100, according to some embodiments. FIGS. 5B and 5C show Shute wire 172 and warp wire 174. In one example, there are three Shute wires 172 in a repeating pattern and eight warp wires 174 in pairs in a unit cell. The number and pattern of Shute wires 172 and warp wires 174 can be adjusted for sufficient operation of desalination device 100. The pattern and pairs of Shute wires 172 and warp wires 174 can be adjusted. Additionally, the Shute wires 172 and warp wires 174 can be tightly weaved together with no observable pore. In one example, the structure of weave material 152 may be is similar to a twilled dutch type mesh. While twilled dutch type mesh may be preferred in certain instances, plain weave, dutch weave and twilled dutch weave may be used. In one example, having three shute wires and eight wrap wires will significantly enhance liquid propagation.

In one example, the Shute wires 172 have a diameter between 0.1 mm and 5 mm. In another example, the Shute wires 172 have a diameter between 0.2 mm and 0.4 mm. For example, the Shute wires 172 can have a diameter of 0.27 mm. In one example, the warp wires 174 have a diameter between 0.1 mm and 5 mm. In another example, the warp wires 174 have a diameter between 0.2 mm and 0.4 mm. For example, the warp wires 174 can have a diameter of 0.27 mm. In one example, the warp wires 174 have a pitch between 0.1 mm and 5 mm. In another example, the warp wires 174 have a pitch between 1 mm and 1.5 mm. The warp wire 174 pitch can be approximately 1.33 mm.

The porosity (ratio of the volume of the voids or pore space divided by the total volume of the material) may be experimentally measured by saturation method. The saturation method includes immersing a material in a water with a known volume and then the total volume was determined. In one example, the porosity of weave material 152 may be greater than 0.05. In another example, the porosity of weave material 152 may be between 0.1 and 0.7. In yet another example, the porosity of weave material 152 may be between 0.3 and 0.4. In one non-limiting example, the porosity of weave material 152 is about 0.34.

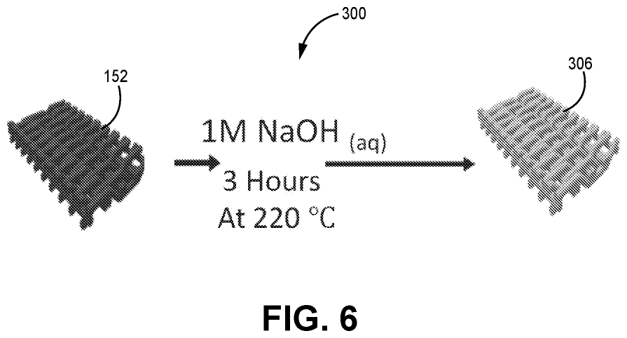

FIG. 6 illustrates an example process of hydrothermal synthesis for the alkaline treatment of weave material 152, according to some embodiments. FIG. 6 shows a titanium mesh etching process 300 for oxidizing titanium and improving anti-corrosiveness for weave material 152 with 1M sodium hydroxide and Ti/TiO₂ weave material 306. In one example, weave material 152 is fully cleaned with one or more of ethanol, acetone, isopropanol, and deionized water and fully dried. In one example, weave material 152 includes a metallic, polymeric, or ceramic material. In another example, weave material 152 includes titanium. Weave material 152 may be chemically etched with 1M sodium hydroxide using hydrothermal synthesis. In one example, hydrothermal synthesis is completed in approximately 3 hours at 220° C. In the example of hydrothermal synthesis, 4 grams of solid NaOH pellets may be mixed with deionized water to make a total 100 ml of 1M NaOH solution. Weave material 152 may be fully immersed by the NaOH solution in a container. The container may be kept inside an oven for 3 hours at 220° C.

After hydrothermal synthesis is completed, Ti/TiO₂ weave material 306 is created. Titanium mesh etching process 300 can increase the surface area of desalination device 100 as well as create a superhydrophilic oxide layer. Ti/TiO₂ weave material 306 can be a TiO₂ nanostructure in contact with titanium. This oxidation is important because Ti/TiO₂ weave material 306 has excellent liquid propagation and anticorrosive properties against saltwater and seawater. These anti-corrosive properties assist with anti-fouling and longevity of the device. Further, the anti-corrosive properties make for a more efficient operation of evaporator component 122 because more solar energy is able to transfer to the material.

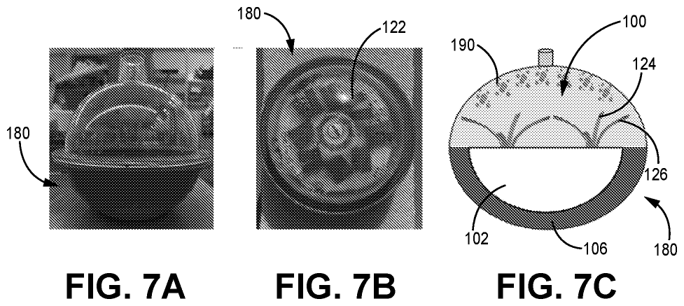

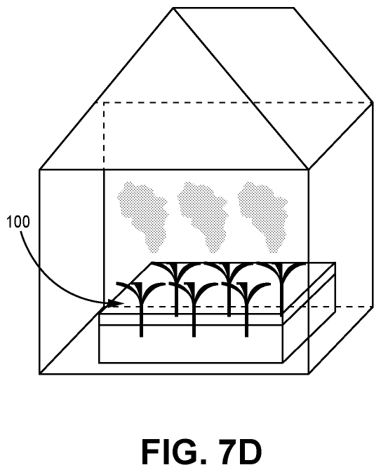

FIGS. 7A-7C illustrate an optional chamber 180 used for water collection, according to some embodiments. FIGS. 7A-7C include desalination device 100, saltwater 102, fresh water 106, evaporator component 122, first side 124, second side 126, chamber 180, and water vapor 190. FIG. 7A illustrates a transparent spherical chamber used for a water collection experiment. FIG. 7B illustrates an experimental setup during an outdoor experiment. FIG. 7C illustrates a schematic diagram for a general experimental setup for the water collection process. In one example, chamber 180 is spherical. In another example, the cross-sectional shape of chamber 180 can be substantially in the form of a square, rectangle, circle, oval, polygon, or triangle. In another example, chamber 180 is transparent for light to pass through. Any portion of chamber 180 can be transparent or opaque. Chamber 180 can be fully sealed. Chamber 180 can hold one or more of desalination device 100, water vapor 190, saltwater 102, and fresh water 106. Chamber 180 can hold water vapor 190 and allow for condensation from water vapor 190 to fresh water 106. Importantly, chamber 180 can assist in water collection of fresh water 106 and can be easily added to desalination device 100 as desired. FIG. 7D illustrates multiple desalination devices 100 in an optional enclosure. This enclosure may be glass or any other transparent material. FIG. 7D illustrates that multiple desalination devices 100 may be used in conjunction with one another and may be used close together.

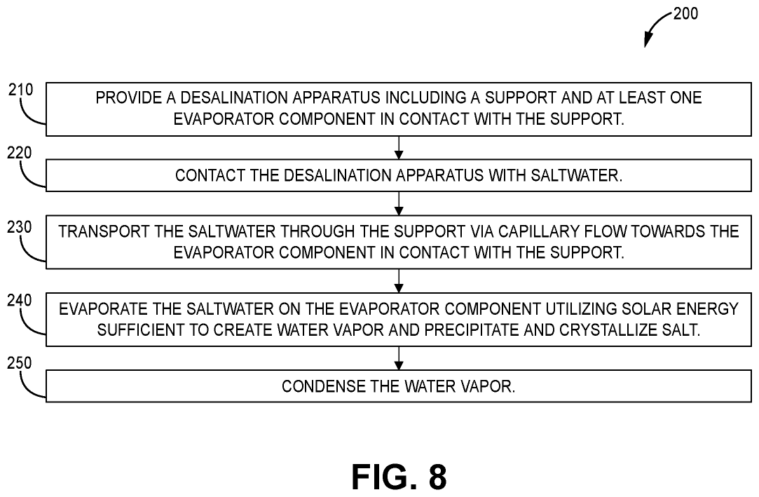

Referring to FIG. 8, a method 200 of desalination and brine treatment is illustrated, according to some embodiments. The method 200 includes the following steps:
STEP 210, PROVIDE A DESALINATION APPARATUS INCLUDING A SUPPORT AND AT LEAST ONE EVAPORATOR COMPONENT IN CONTACT WITH THE SUPPORT, which may be made of the same material, includes providing a desalination apparatus including a support and at least one evaporator component which may be in contact with the support. The support can include one or more polymeric, metallic, and ceramic materials. The support can include one or more of Ti and TiO₂. In one example, the support is substantially hydrophilic. The evaporator component may be in contact with the support. The apparatus can have a first side and a second side. The apparatus can include a hydrophobic material such as Polydimethylsiloxane.
STEP 220, CONTACT THE DESALINATION APPARATUS WITH SALTWATER, includes contacting the desalination apparatus, such as desalination device 100, with saltwater (saline water, brine water, seawater). The desalination apparatus can be floating in or on top of saltwater. In one example, saltwater includes between about 1 wt% salt and 28 wt% salt.
STEP 230, TRANSPORT THE SALTWATER THROUGH THE SUPPORT VIA CAPILLARY FLOW TOWARDS THE EVAPORATOR COMPONENT IN CONTACT WITH THE SUPPORT, includes transporting the saltwater through the support, in a device such as desalination device 100, via capillary flow towards the evaporator component in contact with the support. The capillary flow can be unidirectional. STEP 230 can optionally include transporting the saltwater via unidirectional capillary flow in the absence of sunlight sufficient to diffuse back and remove the crystallized salt from the evaporator component.
STEP 240, EVAPORATE THE SALTWATER ON THE EVAPORATOR COMPONENT UTILIZING SOLAR ENERGY SUFFICIENT TO CREATE WATER VAPOR AND PRECIPITATE AND CRYSTALLIZE SALT, includes evaporating the saltwater on the evaporator component utilizing energy, such as solar energy, sufficient to precipitate and crystallize salt and create water vapor. In one example, solar energy provides sufficient energy to create water vapor from the evaporator component. The energy for evaporation can be any type of energy sufficient to cause evaporation of liquid. The evaporator component can absorb thermal energy for water vaporization. Water vaporization can cause salt precipitation in and around the evaporator component. In one example, the evaporator component holds salt crystals until the salt crystals are shed off. Additionally, salt crystals may shed and fall off at nighttime. Evaporating the saltwater can include reducing salt accumulation on a first side and accumulating the crystallized salt on a second side of the apparatus. Method 200 can utilize a device like desalination device 100. Importantly, method 200 provides an efficient, self-sustaining process for removing salt from water. Method 200 can have no brine liquid discharge.
STEP 250, CONDENSE THE WATER VAPOR, includes condensing the water vapor as a fresh water or substantially salt-free water. Condensing the water vapor may include utilizing a transparent chamber for water collection like FIGS. 7A-7D. The condensed water vapor can be used for generating fresh water.

A key advantage of desalination device 100 is possible one-step fabrication and use of a variety of low-cost commercial materials for design and construction. Desalination device 100 can include effective absorption of sunlight to generate heat, low thermal conductivity material to prevent heat loss from a surface, and hydrophilic porous wicking materials. Additionally, desalination device 100 can combine these properties with anticorrosive and antifouling properties for brackish and saltwater applications. Desalination device 100 can be utilized and scaled for solar vapor generation, freshwater collection, brine treatment, water wicking, and industrial water treatment applications. Desalination device 100 can be utilized for both real seawater and saltwater applications. Desalination device 100 can optionally be referred to as a solar thermal desalination device, a thermal desalination device, and a combined evaporator/crystallizer. Saltwater 102 can optionally be referred to as brine, seawater, saltwater, and brackish water.

### Example 1

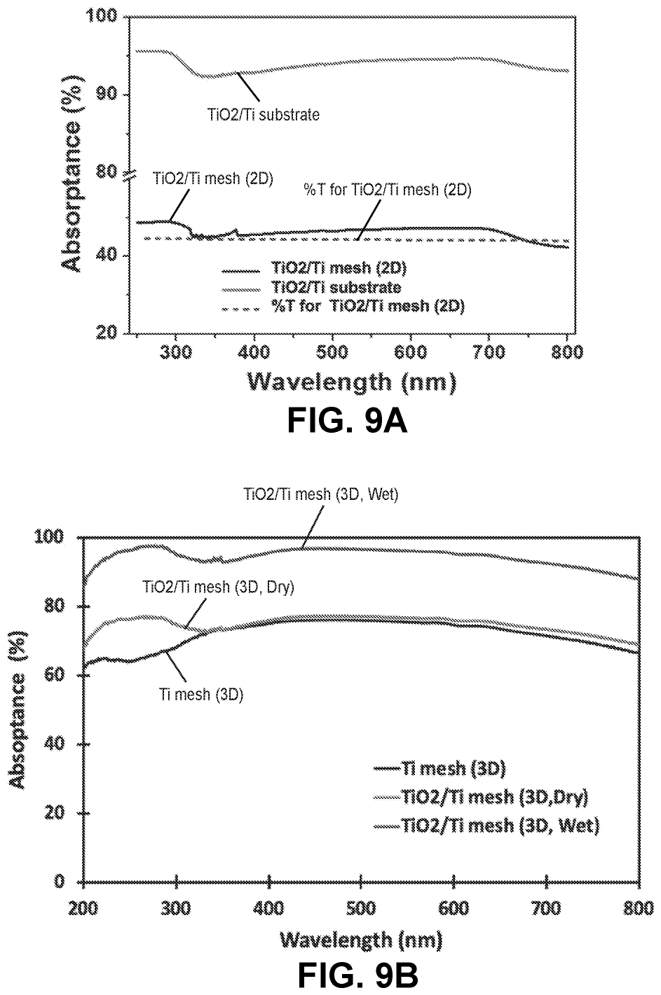

FIG. 9A illustrates the measured absorptance at various wavelengths of Ti/TiO₂ flat substrate and 2D Ti/TiO₂ weave material, according to some embodiments. FIG. 9B illustrates the measured absorptance of 3D Ti/TiO₂ weave material, 3D Ti/TiO₂ dry weave material, and 3D Ti/TiO₂ wet weave material, according to some embodiments. Since the evaporation process on desalination device 100 can be driven by solar energy, light absorption characteristics of the evaporator material have importance for achieving high efficiency. In one example, the 3D Ti/TiO₂ dry weave material exhibited solar absorptance of 75.45% in the range of 200-800 nm, while the 3D Ti/TiO₂ wet weave material exhibited solar absorptance of 90%.

### Example 2

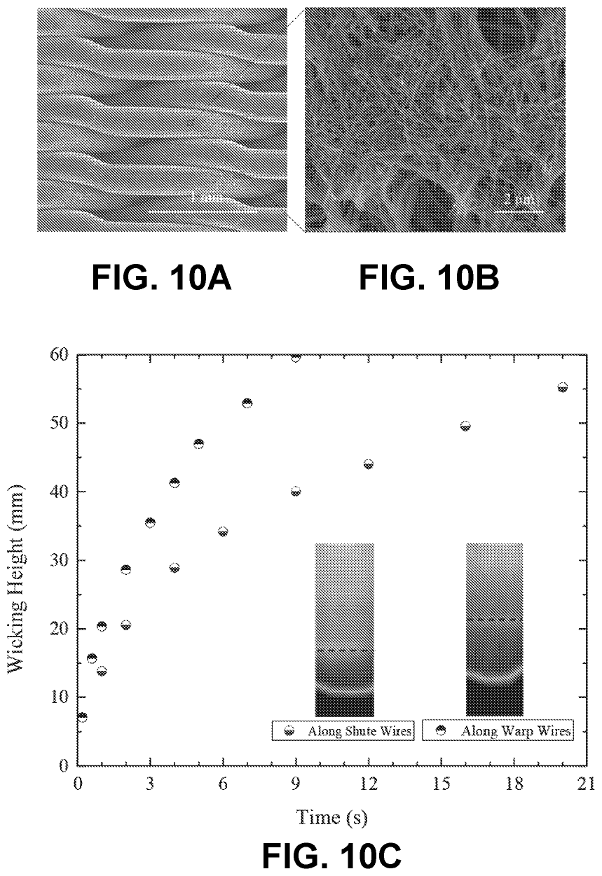

FIG. 10A illustrates low magnification SEM images of as-oxidized TiO₂/Ti mesh (1M NaOH_{(aq)}, 220° C.), according to some embodiments. FIG. 10B illustrates high magnification SEM images of as-oxidized TiO₂/Ti mesh (1M NaOH_{(aq)}, 220° C.), according to some embodiments. FIG. 10C illustrates evolution of the waterfront and wicking of the water with time for the oxidized titanium mesh, according to some embodiments. The wicking performance of oxidized mesh can be observed by recording the water propagation process by locating the propagation front. The evolution of the waterfront, observed as a function of time as shown in FIG. 10C in two different cases, indicates the high liquid propagation speed. The propagation of the liquid front is identifiable in the IR images owing to the different emissivity of the wetted and non-wetted regions of the mesh. It can also be observed that the color of the infrared image is not the same for the wetted part of the mesh. It is due to the varying thickness of the liquid films along the propagation line.

### Example 3

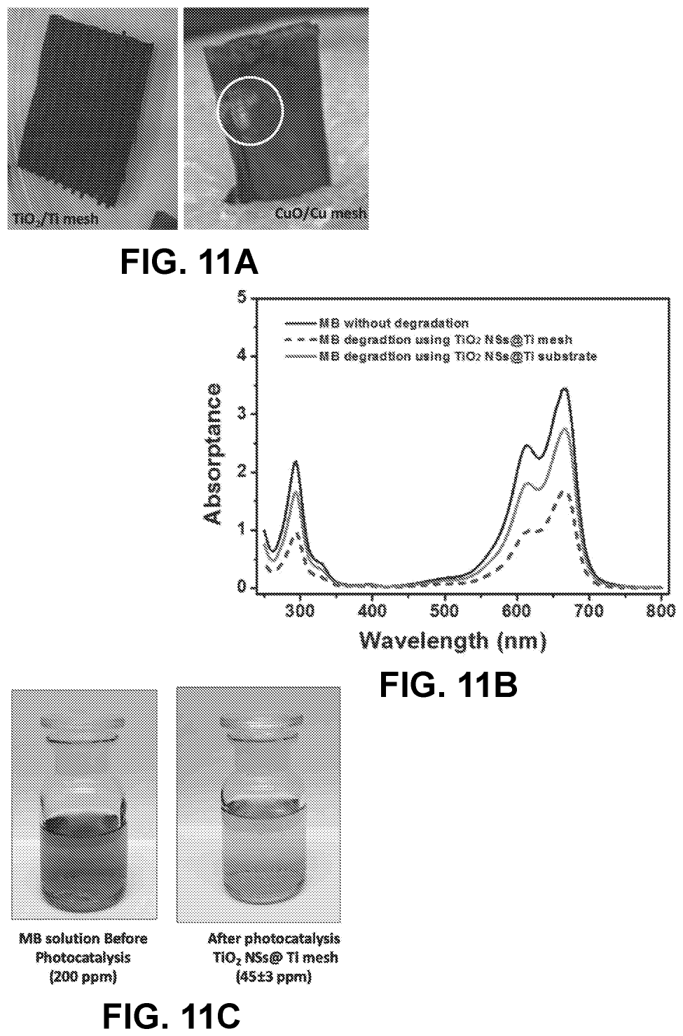

FIG. 11A illustrates optical images comparing the anticorrosive performance of TiO₂/Ti and CuO/Cu mesh after 6 hours of dipping in water containing 3.5 wt% NaCl, according to some embodiments. FIG. 11B illustrates measured absorptance spectra of methylene blue to check the antifouling performance, according to some embodiments. FIG. 11C illustrates methylene blue solution before photocatalysis (200 ppm) and after photocatalysis TiO₂ NSs@ Ti mesh (45 ±3 ppm), according to some embodiments. Long-term operation is crucial for highly efficient desalination devices. A desalination device should have a capacity to resist fouling, scaling, and corrosion for an extended period of time. The TiO₂/Ti mesh shows greater anti-corrosiveness against saltwater compared to CuO/Cu mesh. Oxidized TiO₂/Ti mesh has good photocatalytic potential and has resistance for organic fouling. Methylene blue was used as a model dye. To verify the photocatalytic performance, solution-based methylene blue degradation experiments were performed using 1 sun intensity irradiation. After 2 hours of illumination, the resulting solution was characterized by a UV/VIS/NIR spectrometer. The decrease of absorptance peak is the result of photocatalytic decomposition of methylene blue by TiO₂/Ti mesh under sunlight illumination, as shown in FIG. 11B.

### Example 4

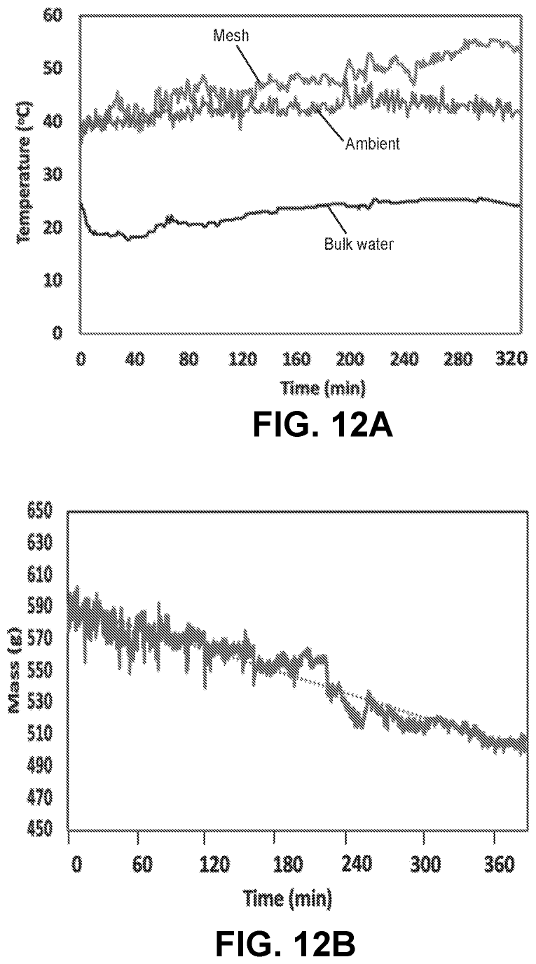

An outdoor experiment under direct solar illumination demonstrated the performance of desalination device 100 to treat the salt water and crystallize the salts at the edges of the TiO₂/Ti mesh foldable structure for real applications. The desalination device 100 was placed on the roof top of Khalifa University at noon time for all experiments. Thermocouples were used to measure the mesh, water bulk and ambient temperatures. FIG. 12A illustrates temperature as a function of time for an outdoor experiment using a TiO₂/Ti mesh foldable structure (with four evaporator components) for 3.5wt% salt concentration, according to some embodiments. FIG. 12B illustrates mass change as a function of time for an outdoor experiment using a TiO₂/Ti mesh foldable structure (four evaporator components) for 3.5 wt% salt concentration, according to some embodiments. The results confirmed the capability of the titanium mesh for solar thermal energy conversion and a high temperature more than 50° C. was maintained through the day for stable evaporation. These results showed excellent performance in terms of artificial saline water evaporation. The evaporation can be enhanced by increasing the number of the evaporator components 122 of TiO₂/Ti mesh, which will consequently enlarge the evaporation surface area.

### Example 5

Regarding water collection, a transparent spherical chamber 180 was used as a solar still in order to investigate the flower-like structure performance as shown in FIG. 7A. To increase the evaporation area, four evaporator components were used in the experiment and a disposable bowl made from foam that contains seawater from near Al-Maqtaa bridge (Abu Dhabi) was utilized as shown in FIGS. 7B and 7D. The experiment took place on the roof top of Khalifa university from 11:00 am on 8^{th} of Feb to 11:00 am on 9^{th} of Feb with a total immersion period of 24 hours. An insulating foam was kept on the bottom of the chamber to reduce the ground heating. During the experiment, the Direct Normal Irradiance was 708 W/m² and the system was able to produce fresh water with a flux of 4.4 L/m²-day, which is enough to satisfy daily individual drinking needs. Moreover, it was noticed that during the night when the ambient temperature is decreased, condensation occurred on the outer surface of top cover. Thus, the water collection chamber can also collect condensed water efficiently during the night.

### Example 6

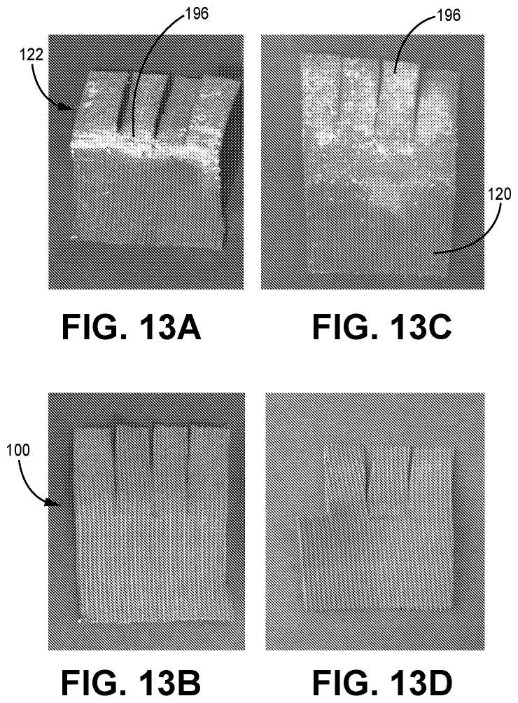

In order to demonstrate the capability of a device for continuous freshwater production from seawater, desalination device 100 was left in the roof top of Khalifa University on 9th of April 2022 and it was noticed that after 8 consecutive days of operation, the four flower-like meshes were fully saturated with apparent salt crystals, as shown in FIG. 13A. To clean the mesh, 3 L/m2 was used, which is around 8.5 % of the total water production amount (˜35.2 L/m2). Therefore, the net freshwater production flux is 4.0 L/m2-day. In this context, the net freshwater production flux becomes 4.4 L/m2-day.

FIG. 13A illustrates desalination device 100 with evaporator component 122 and salt crystals 196 before cleaning with collected water, according to some embodiments. FIG. 13B illustrates desalination device 100 after cleaning with collected water, according to some embodiments. Four evaporator components 122 are shown in FIGS. 13A-13B. Before cleaning the desalination device 100 with collected water, salt crystals 196 are present on the evaporator component 122. After cleaning the desalination device 100 with collected water, salt crystals 196 are no longer visible and have been substantially removed.

FIG. 13C illustrates desalination device 100 with salt crystals 196 before cleaning with seawater, according to some embodiments. FIG. 13D illustrates desalination device 100 after cleaning with seawater, according to some embodiments. Four evaporator components 122 are shown in FIG. 13C and three evaporator components 122 are shown in FIG. 13D. Before cleaning the desalination device 100 with seawater water, salt crystals 196 are present on the evaporator component 122. After cleaning the desalination device 100 with seawater, salt crystals 196 are no longer visible and have been substantially removed.

### Example 7

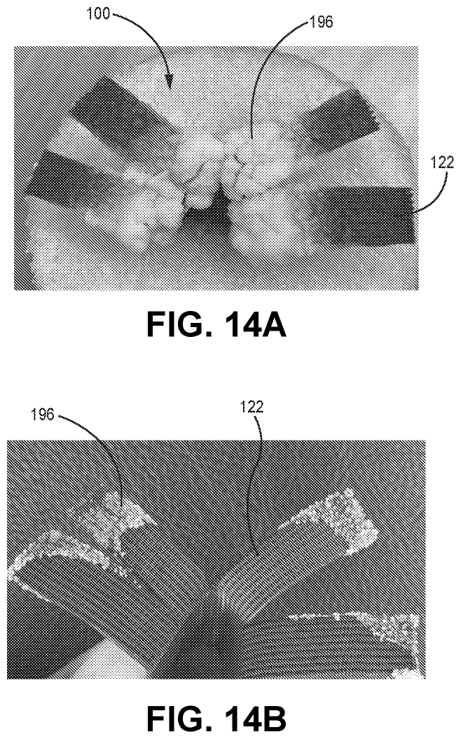

Apart from utilizing the lab-made 3.5 wt% aqueous solution of NaCl, the performance of the desalination device 100 was investigated under highly concentrated artificial brine (10.5 wt%) and near saturation brine (24 wt%). The weight of the mesh was measured initially and after the experiment in order to determine the weight of crystalized salt. The desalination device 100 using 10.5 wt% brine experiment provided an amount of salt equal to 0.11 kg/m² h under simulated 1 sun irradiance. The desalination device 100 using 24 wt% brine placed on the roof top of the university building provided salt with a rate of 0.24 kg/m² h as shown in FIGS. 14A and 14B. FIG. 14A illustrates salt crystals 196 on desalination device 100 evaporator components 122 using artificial brines of 24 wt%, according to some embodiments. FIG. 14B illustrates salt crystals 196 on desalination device 100 evaporator components 122 using artificial brines of 10.5 wt%, according to some embodiments. Increased salt crystallization was discovered for the 24 wt% brine.

### Example 8

The main driving force for the distillation processes is the sunlight on the top surface of the Ti/TiO₂ mesh. Hence, increasing the top surface area will boost the input solar energy and enhance the performance of the designed device. One way to accomplish this is to increase the surface area by adding another layer of the hydrophilic mesh on the top of the flower shaped structure that is coated with the Polydimethylsiloxane (PDMS) material. PDMS as shown in FIG. 4A is an inexpensive transparent hydrophobic polymer that can be deposited as a thin film on the top of the base mesh. PDMS is substantially non-water-permeable. This PDMS material can prevent the salt precipitation in top pores and the associated light reflection while forcing the saline water to propagate in the original flower-shaped mesh, without sacrificing the sunlight absorption and vapor generation capability of the flower-like structure. The hydrophilicity of the bottom flower-like structure is maintained to enhance the water propagation, transfer the heat from the top solar-exposed surface to the bottom and increase the evaporation area (FIG. 4A). The saltwater is forced to propagate on the bottom side and the salt can be self-defoliated by gravity.

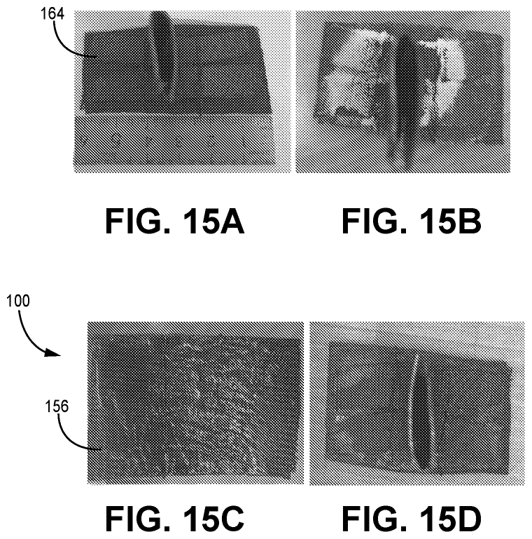

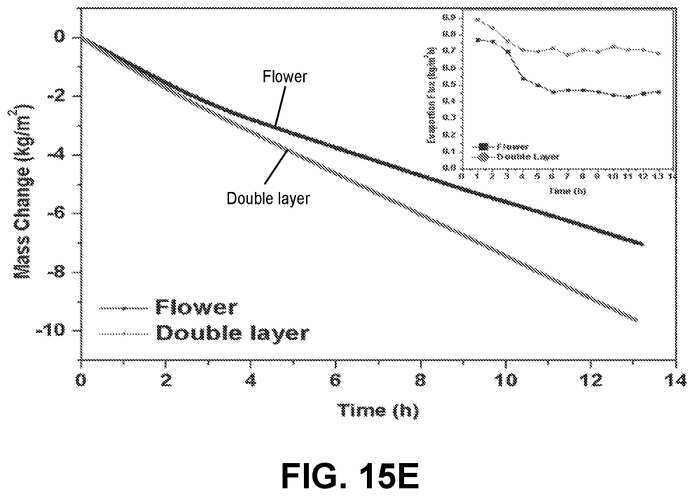

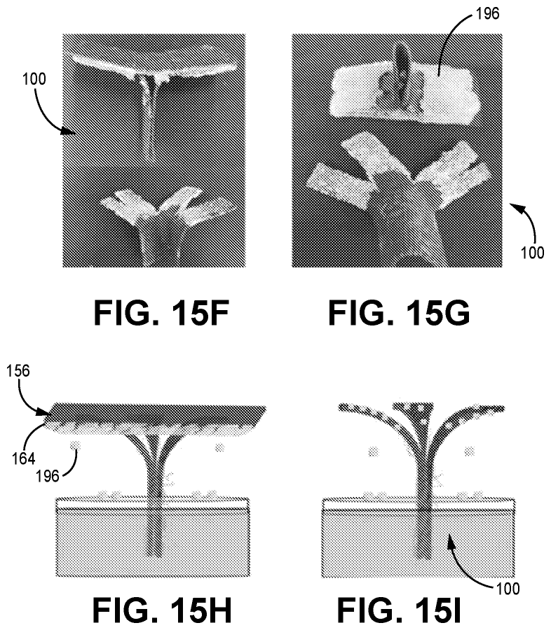

FIGS. 15A-15D illustrate a desalination device 100 with a hydrophobic layer 156 and base layer 164. Desalination device 100 was investigated under 1 simulated sun and using artificial brine with a salinity of 24 wt% for a period of 13 hours. FIG. 15A illustrates a bottom view of a desalination device 100 before being placed in saltwater, according to some embodiments. FIG. 15B illustrates a bottom view of a desalination device 100 after an experiment using 24 wt% salt, according to some embodiments. FIG. 15B shows the bottom side of desalination device 100 after an experiment where all salt crystals are only accumulated on the bottom surface. FIG. 15C illustrates a top view of a desalination device 100 with hydrophobic layer 156 shown after an experiment using 24 wt% salt, according to some embodiments. As shown in FIGS. 15B and 15C, most of the salt crystals 196 are shown on the bottom of desalination device 100. FIG. 15D illustrates a bottom view of a desalination device 100 after self-cleaning at night due to the back diffusion of salt and passive peeling of salt, according to some embodiments.

FIG. 15E illustrates a performance comparison between a desalination device 100 as a flower shape (top curve) and a desalination device 100 with a hydrophobic layer 156 and base layer 164 (bottom curve) in terms of evaporation flux, according to some embodiments. In this example, hydrophobic layer 156 is Polydimethylsiloxane and base layer 164 includes Ti/TiO₂ such as Ti/TiO₂ weave material 306. Using the flower like structure as a reference for comparison, the double-layer device recorded a high stable cumulative evaporation flux of 8.2 kg/m² h and the rate of accumulated salt was equal to 0.16 kg/m² h where the flower shaped device recorded a cumulative evaporation flux of 6 kg/m² h and a salt collection rate of 0.11 kg/m² h as shown in FIG. 15E.

By utilizing a previously mentioned double-layer surface on the top, the saline water is forced to propagate only in the bottom side of the flower shaped mesh. Thus, the salt crystals could be self-defoliated easily by the impact of gravity. This is important because it provides a self-sustaining and efficient way to remove salt. Furthermore, this process is important because there is zero brine liquid discharge.

It was investigated how the salt can be passively shed and peeled off from the devices such as the flower shaped device and the double-layer device. Initially, a thick layer of salt was accumulated on both devices due to the continuous previous water evaporation experiments. The salt weight on both devices was equal to 1.6 grams as shown in FIGS. 15F and 15G. Both devices were placed in direct contact with deionized water for three hours as illustrated in FIGS. 15H and 15I. When the two devices are in contact with water, regular liquid propagation will occur from the bulk deionized water to the mesh. Continuous liquid transport with the absence of direct solar light will lead to dissolve the crystallized salt and diffuse it back to the bulk water.

FIG. 15F illustrates a side view of 1.6 g of salt accumulated in both a desalination device 100 with hydrophobic layer 156 and base layer 164 and a desalination device 100 with a flower-like shape, according to some embodiments. FIG. 15G illustrates a bottom view of salt accumulated in both a desalination device 100 with hydrophobic layer 156 and base layer 164 and a desalination device 100 with a flower-like shape, according to some embodiments. FIGS. 15F and 15G show salt crystals 196 on the bottom of desalination device 100.

FIG. 15H illustrates a schematic of passive salt peeling from a desalination device 100 with hydrophobic layer 156 and base layer 164, according to some embodiments. Salt crystals 196 are shown falling from the desalination device 100. FIG. 15I illustrates a schematic of passive salt peeling from desalination device 100 with a flower-like shape, according to some embodiments. Salt crystals 196 are shown falling from desalination device 100.

In addition, it is noteworthy that owing to high liquid propagation, continuous water wicking during the night along with low ambient temperature in the absence of solar light will lead to mesh cleaning and force the salt to be peeled off or back diffused to the bulk water container as presented on FIG. 15D. Salt crystallization during the day and passive salt cleaning during the night will ensure that the device will work for long period of time without any maintenance or performance degradation.

### Example 9

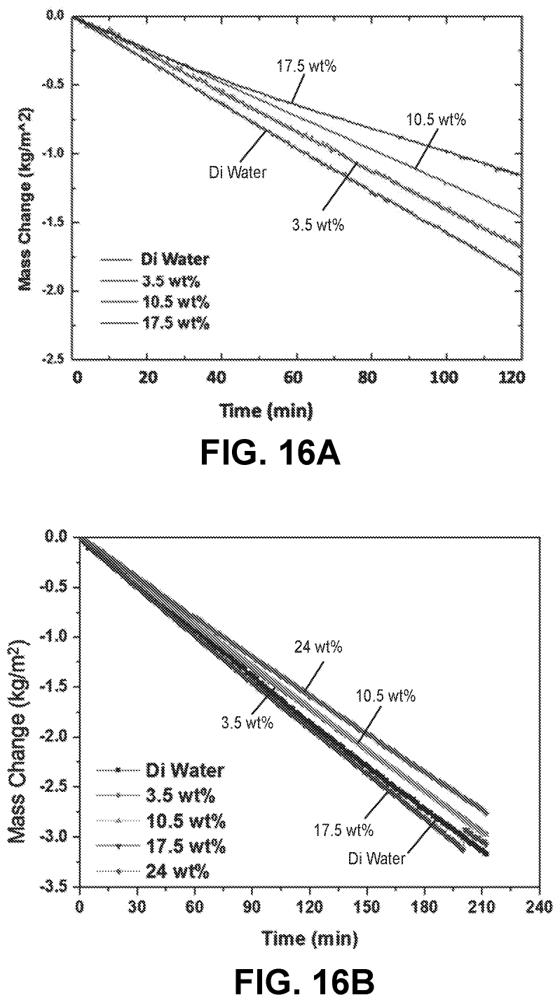

In order to investigate the effect of various salinity levels of water on the performance of the flower shaped solar thermal desalination device 100 with four evaporator components 122, four various samples of saltwater were studied with different concentrations i. e Deionized water, 3.5 wt%, 10.5 wt% and 17.5 wt% of aqueous NaCl solutions were used to measure the evaporation flux under simulated one sun using solar simulator for a period of 2 hours. As shown on FIG. 16A, the experiments revealed that the evaporation flux is affected by the salt concentration. The evaporation flux for different salinities based on the total evaporation area are 0.93 kg/m² h for the deionized water, 0.85 kg/m² h for the 3.5 wt% solution, and 0.73 kg/m² h and 0.54 kg/m² h for the 10.5 wt% and 17.5 wt% solutions respectively. The evaporation fluxes in terms of the top solar illuminated area are 1.86 kg/m² h for the deionized water, 1.7 kg/m² h for the 3.5 wt% solution, 1.46 kg/m² h for the 10.5 wt% solution, and 1.08 kg/m² h for the 17.5 wt% solution. Increasing saltwater concentration also increases the salt crystallization on the top photothermal layer, thus, blocking the pores and reflecting the sunlight, leading to reduce the overall evaporation flux.

The study of investigating the effect of different salinity solutions on the performance of the double-layer desalination device 100 was conducted using five samples of saltwater with different concentrations, including, deionized water, 3.5 wt%, 10.5 wt%, 17.5 wt% and 24 wt% of aqueous NaCl solutions under simulated one sun. The obtained results revealed that the evaporation flux is slightly influenced by the change of the salinity, owing to the fact that the salt crystals will be accumulated only at the bottom side of the device, which resulted in maintaining a clean and salt free sunlight absorption layer on the top. As shown in FIG. 16B, the recorded evaporation fluxes in terms of total evaporation area are 0.93 kg/m² h for the pure deionized water, 0.9 kg/m² h for the 3.5 wt% solution and 0.87 kg/m² h, 0.97 kg/m² h, 0.9 kg/m² h for the 10.5 wt%, 17.5 wt% and 24 wt% solutions respectively. The evaporation fluxes based on the top solar illuminated area are 1.07 kg/m² h for the deionized water, 1.04 kg/m² h for the 3.5 wt% solution, 1.0 kg/m² h for the 10.5 wt% solution, 1.11 kg/m² h for the 17.5 wt% solution, and 1.04 kg/m² h for the 24 wt% solution.

### Example 10

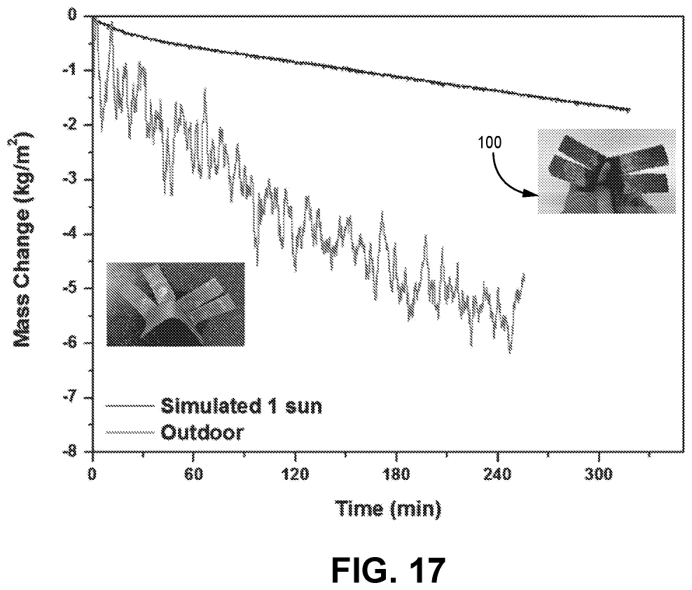

In addition, the flower shaped structure was investigated using a 24 wt% near saturation brine obtained from Al-Maqtaa bridge in Abu Dhabi. The experiments were made under the lab environment using 1 simulated sun and under outdoor environment on 13th of Feb. The two different experiments revealed that the salt accumulation was homogenously distributed through the surface of the mesh as shown in FIG. 17.

FIG. 17 illustrates a comparison between the evaporation performance of the indoor and outdoor experiments for the real 24 wt% seawater brine in desalination device 100 with a flower-like shape, according to some embodiments. Considering the evaporation performance, the flower-like structure recorded a stable evaporation flux equal to 0.6 kg/m² h under the 1 simulated sun (top curve in FIG. 17). On the other hand, under the outdoor environment, the device recorded a significant evaporation flux of 2 kg/m² h (bottom). The fluctuations in the outdoor experiment data are due to the wind effect and ambient heating.

Example 11

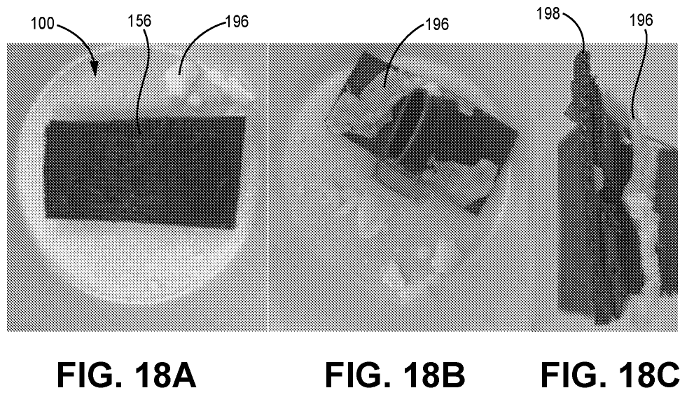

FIGS. 18A-18C illustrate a double-layer desalination device 100 with hydrophobic layer 156 and salt crystals 196. FIG. 18A illustrates the amount of self-removed salt crystals 196 from desalination device 100 with hydrophobic layer 156, according to some embodiments. FIG. 18B illustrates the amount of self-removed salt crystals 196 from desalination device 100 with hydrophobic layer 156, according to some embodiments. FIG. 18C illustrates a dissolved interfacial layer 198 in desalination device 100 with hydrophobic layer 156, according to some embodiments.

The accumulated salt is consisted of many layers. Thus, dissolving the interfacial layer of salt that is adhered to the mesh as shown in FIG. 18C will lead to peel lower layers passively due to gravity as presented in FIGS. 18A and 18B. The rate of self-defoliated salt from the new double-layer device was equal to 0.14 kg/m² h as shown in FIG. 18B, where the previous flower like device peeled off 0.1 kg/m² h of salt passively.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

What is claimed is:

1. A desalination and brine treatment apparatus comprising:
a support; and
at least one evaporator component in contact with the support;
wherein one or more of the support and the evaporator component include mesh.

2. The apparatus of claim 1, wherein the mesh includes one or more materials selected from metal, polymer, and ceramics.

3. The apparatus of claim 1, wherein the mesh includes a flexible porous sheet shaped like a flower petal.

4. The apparatus of claim 1 further comprising a hydrophilic nanostructured layer for efficient liquid propagation with one or more of anticorrosive properties and effective sunlight absorption.

5. The apparatus of claim 4, wherein the hydrophilic nanostructured layer includes TiO₂.

6. The apparatus of claim 1 further comprising a hydrophobic layer.

7. The apparatus of claim 6, wherein the hydrophobic layer includes Polydimethylsiloxane.

8. The apparatus of claim 1, wherein the evaporator component further comprises a sub-structure extending distally from the evaporator component.

9. The apparatus of claim 8, wherein the sub-structure increases surface area of the evaporator component for enhanced salt nucleation and water evaporation.

10. The apparatus of claim 1, wherein the mesh is substantially in the form of twilled Dutch weave.

11. The apparatus of claim 1, wherein the mesh comprises three Shute wires in a repeating pattern and eight warp wires in pairs in a unit cell and one or more of the Shute wires and the warp wires have a diameter between 0.1 mm and 5 mm.

12. A method of desalination and brine treatment, the method comprising:
providing a desalination apparatus including:
a support; and
at least one evaporator component in contact with the support;
contacting the desalination apparatus with saltwater;
transporting the saltwater through the support via capillary flow towards the evaporator component in contact with support;
evaporating the saltwater on the evaporator component utilizing solar energy sufficient to create water vapor and precipitate and crystallize salt; and
condensing the water vapor.

13. The method of claim 12, wherein the desalination apparatus further comprises a first side and a second side and evaporating the saltwater includes absorbing sunlight on the first side and accumulating the crystallized salt on the second side.

14. The method of claim 13 further comprising transporting the saltwater via unidirectional capillary flow in the absence of sunlight sufficient to remove the crystallized salt from the second side.

15. The method of claim 12, wherein the desalination and brine treatment generates the water vapor and the salt in a chamber sufficient to produce freshwater without saline liquid discharge.

16. The method of claim 12, wherein the desalination apparatus further includes a mesh layer comprising one or more of Ti and TiO₂.

17. The method of claim 12, wherein the desalination apparatus further comprises a hydrophobic layer comprising Polydimethylsiloxane.

18. A porous apparatus for saltwater desalination comprising:
a hydrophilic support; and
an evaporator component with a base layer and a Polydimethylsiloxane hydrophobic film layer;
wherein the hydrophilic support is in contact with the evaporator component and the hydrophilic support and the base layer include a mesh including one or more materials selected from Ti and TiO₂.

19. The porous apparatus of claim 18, wherein the evaporator component further comprises a sub-structure extending distally from the evaporator component sufficient for enhanced salt-peeling capability.

20. The porous apparatus of claim 18 further comprising an additional layer between the hydrophilic support and the Polydimethylsiloxane hydrophobic film layer, wherein the additional layer is substantially hydrophilic.
